(19) United States
(12) Patent Application Publication
(10) Pub. No.: US 2018/0164568 A1
(43) Pub. Date: Jun. 14, 2018

(54) MICROSCOPE WITH FRICTION DRIVES

(71) Applicant: Leica Microsystems CMS GmbH, Wetzlar (DE)

(72) Inventor: Martin KUBEK, Driedorf (DE)

(21) Appl. No.: 15/580,286

(22) PCT Filed: Jun. 8, 2016
(86) PCT No.: PCT/EP2016/062943

§ 371 Date: Dec. 7, 2017

(30) Foreign Application Priority Data
Jun. 10, 2015 (DE) 10 2015 109 149.6

(51) Int. Cl. G02B 21/24; G02B 7/16; G02B 21/26

(52) U.S. Cl. CPC G02B 21/248; G02B 21/06; G02B 21/26; G02B 7/16

(57) ABSTRACT

The invention relates to a microscope (10, 50) having a specimen stage (12) movable in an X direction and/or a Y direction and having an objective turret (16), the microscope (10, 50) encompassing a first drive unit (14a) with which the specimen stage (12) is movable in the X direction, a second drive unit (14b) with which the specimen stage (12) is movable in the Y direction, and/or a third drive unit (14c) with which the objective turret (16) is rotatable. The connections between the drive units (14a, 14b, 14c) and the specimen stage or the objective turret (16) are respectively embodied as a frictional connection.

### CROSS-REFERENCE TO RELATED APPLICATIONS

The present application is the U.S. national phase of International Application No. PCT/EP2016/062943 filed Jun. 8, 2016, which claims priority of German Application No. 10 2015 109 149.6 filed Jun. 10, 2015, the entire disclosure of which is incorporated herein by reference.

### FIELD OF THE INVENTION

The invention relates to a microscope that comprises a specimen stage movable in an X direction and a Y direction, and an objective turret. The microscope furthermore has a first drive unit with the aid of which the specimen stage is movable in the X direction, and a second drive unit with the aid of which the specimen stage is movable in the Y direction. Also provided is a third drive unit with the aid of which the objective turret is rotatable.

### BACKGROUND OF THE INVENTION

In known microscopes, force and torque are transferred from the drive units to the respective elements to be displaced, i.e. for example the specimen stage or the objective turret, via a positively engaging connection. Provided for this purpose, in particular, are gears, toothed racks, spindles, or toothed belts, by way of which the drive unit is connected to the element that is to be moved.

Positively engaging force transfer systems of this kind are disadvantageous firstly in that they require very high precision in order to run quietly. This requires very small tolerances in the context of production and assembly, making the microscopes very expensive to manufacture.

In addition, microscopes having a positively engaging force transfer system always exhibit hysteresis behavior upon a change in the direction of motion, making it more difficult to return precisely to desired positions.

The positively engaging drives are furthermore relatively loud and exhibit poor smoothness. Positively engaging drives of this kind also must be regularly lubricated, resulting in a recurring maintenance outlay.

### SUMMARY OF THE INVENTION

The object of the invention is to describe a microscope that can be manufactured inexpensively and provides smooth, low-noise operation along with precise positioning of the movable elements.

This object is achieved with a microscope having the features disclosed herein. Advantageous refinements of the invention are described in the present specification.

According to the present invention, the microscope comprises a first drive unit with the aid of which the specimen stage is movable in the X direction. A frictional connection for transferring a torque and/or a force is embodied between the first drive unit and the specimen stage. Additionally or alternatively, the microscope can encompass a second drive unit with the aid of which the specimen stage is movable in the Y direction. The connection between this second drive unit and the specimen stage is likewise embodied as a frictional connection for transferring a torque and/or a force. Additionally or alternatively, a third drive unit, with the aid of which the objective turret is rotatable, can also be provided. The connection between the third drive unit and the objective turret is also embodied as a frictional connection for transferring a torque and/or a force from the third drive unit to the objective turret.

A “frictional connection” is understood to mean in particular that the torque and/or a force is transferred in exclusively frictionally engaging fashion, i.e. that the torque transfer and/or force transfer occurs exclusively by way of the friction existing between the respective drive unit and the specimen stage or objective turret. Frictionally engaging connections are often also referred to as “nonpositive” connections.

A “frictional connection” is understood in particular to mean that the torque transfer and/or force transfer occurs exclusively in frictionally engaging fashion, and no positive engagement exists between the drive unit and the respective moved element. In particular, the connection between the respective drive unit and the specimen stage or objective turret is embodied in non-toothed fashion.

Frictionally engaging connections of this kind offer a number of advantages as compared with the positively engaging connections ordinarily used in microscopes.

On the one hand, frictionally engaging connections offer substantially smoother operation than positively engaging connections by the fact that vibrations of the system are avoided, with the result that operating convenience for the microscope is enhanced. On the other hand, frictionally engaging connections are considerably quieter as compared with positively engaging connections, which further enhances the operating convenience of the microscope.

A further problem that exists with positively engaging connections, in particular with gears or toothed racks, is that upon a reversal of the motion direction, the teeth of the driven coupling element firstly must be moved from the one side of that region of the tooth set into which they are engaging to the other side of the tooth set, before they can actually move the element into which they are engaging. This produces a hysteresis behavior that is disadvantageous during use. Very stringent requirements in terms of tolerance must be applied in order to avoid this, necessitating very precise and therefore expensive manufacturing. This hysteresis behavior does not exist with frictionally engaging connections, however, resulting in simple and quick manufacture and assembly.

The use of frictionally engaging connections within the microscope thus makes possible simple and inexpensive manufacture and assembly, but still smooth, quiet, and precise operation.

In a particularly preferred embodiment of the invention, a flexible frictional drive is embodied respectively between the first drive unit and the specimen stage, between the second drive unit and the specimen stage, and/or between the third drive unit and the objective turret. A “flexible frictional drive” is understood to mean that the connection between the drive unit and the specimen stage or objective turret is embodied elastically, so that tolerances are automatically compensated for.

In a particularly preferred embodiment of the invention, the first, the second, and/or the third drive unit respectively comprises a first coupling element, and the specimen stage and/or the objective turret respectively comprises a second coupling element, the first coupling element being respectively coupled in frictionally engaging fashion to the respective second coupling element. The above-described frictionally engaging transfer of power and torque is thereby achieved in simple fashion.

In particular, at least one elastic element is respectively arranged between the two coupling elements, that elastic element being preloaded between the two respective coupling elements. The result is on the one hand that the frictional force which exists is increased, and on the other hand that tolerances are compensated for. Particularly simple manufacture is furthermore achieved. Preloading is achieved in particular by the fact that the spacing between the two coupling elements is smaller than the thickness of the elastic element.

The elastic element is embodied, in particular, from rubber.

In a particularly preferred embodiment of the invention, the elastic element is embodied from ethylene propylene diene rubber (EPDM). EPDM has the advantage that on the one hand it possesses a high coefficient of friction so that a large frictional force is generated, and on the other hand that the aging which occurs is not as great as with “normal” rubber, so that the elastic element does not need to be regularly replaced.

The elastic element is, in particular, fastened in nonrotating and stationary fashion on the respective second coupling element, i.e. its position relative to the coupling element on which it is fastened does not change during operation.

It is particularly advantageous if the coupling element on which the respective elastic element is fastened comprises a respective groove in which the elastic element is at least partly arranged. This groove, in particular, prevents slippage of the elastic element. In addition, the elastic element is itself arranged inside that groove, in particular, in preloaded fashion, so that rotation of the elastic element within the groove is also avoided.

In an alternative embodiment of the invention, at least two elastic elements are arranged between the two coupling elements respectively coupled to one another, the elastic elements being preloaded between those two coupling elements, and one of the two elastic elements being fastened in nonrotatable and stationary fashion on the first coupling element, and the other elastic element on the pertinent second coupling element.

Thanks to the use of two elastic elements between the two respective coupling elements, a greater frictional force and thus even more reliable transfer of force and torque are achieved.

The two elastic elements are arranged in particular with a mutual offset, so that they do not contact one another. This prevents the transfer of force and torque from occurring between the two elastic elements themselves, which might result in unstable transfer.

In a preferred embodiment of the invention, the first coupling element is embodied as a wheel or shaft. In this case the elastic element extends, in particular, around the entire circumference of the wheel or shaft.

The second coupling element, on which the moved part, i.e. the specimen stage or objective turret, is arranged, is embodied in particular as a wheel or rod.

It is furthermore advantageous if the first, the second, and/or the third drive unit respectively encompass an electric motor on whose respective drive shaft the first coupling element is mounted. Precise control of the motion of the specimen stage and of the objective turret is thereby achieved.

In a particularly preferred embodiment of the invention, the microscope comprises a rotary disk in which at least one fluorescence cube and/or at least one other optical element are arranged. The microscope comprises a fourth drive unit by way of which the rotary disk is rotatable. A frictional connection, for transferring from the fourth drive unit to the rotary disk a torque and/or a force for rotating the rotary disk, is embodied between the fourth drive unit and the rotary disk.

This frictional connection can be refined in particular with the same features that have been described previously for the frictional connection between the first drive unit and the specimen stage, the second drive unit and the specimen stage, and/or the third drive unit and the objective turret.

Displacement of the rotary disk by way of a smooth-running, quiet coupling of simple configuration can also thereby be achieved.

Further features and advantages of the invention are evident from the description below, which explains the invention in further detail on the basis of exemplifying embodiment in conjunction with the appended Figures.

### BRIEF DESCRIPTION OF THE DRAWING VIEWS

In the drawings:

FIG. 1 is a highly simplified schematic depiction of an upright microscope;

FIG. 2 is a schematic perspective depiction of the microscope according to FIG. 1;

FIG. 3 is a partly sectioned schematic depiction of the connection between the specimen stage and a drive unit of the microscope according to FIGS. 1 and 2;

FIG. 4a is a sectioned schematic depiction of the connection between the rotary disk and a drive unit for rotating the rotary disk of the microscope according to FIGS. 1 and 2, in accordance with a first embodiment;

FIG. 4b is a sectioned schematic depiction of the connection between the rotary disk and a drive unit for rotating the rotary disk of the microscope according to FIGS. 1 and 2, in accordance with a second embodiment; and

FIG. 5 is a highly simplified schematic perspective depiction of an inverted microscope.

### DETAILED DESCRIPTION OF THE INVENTION

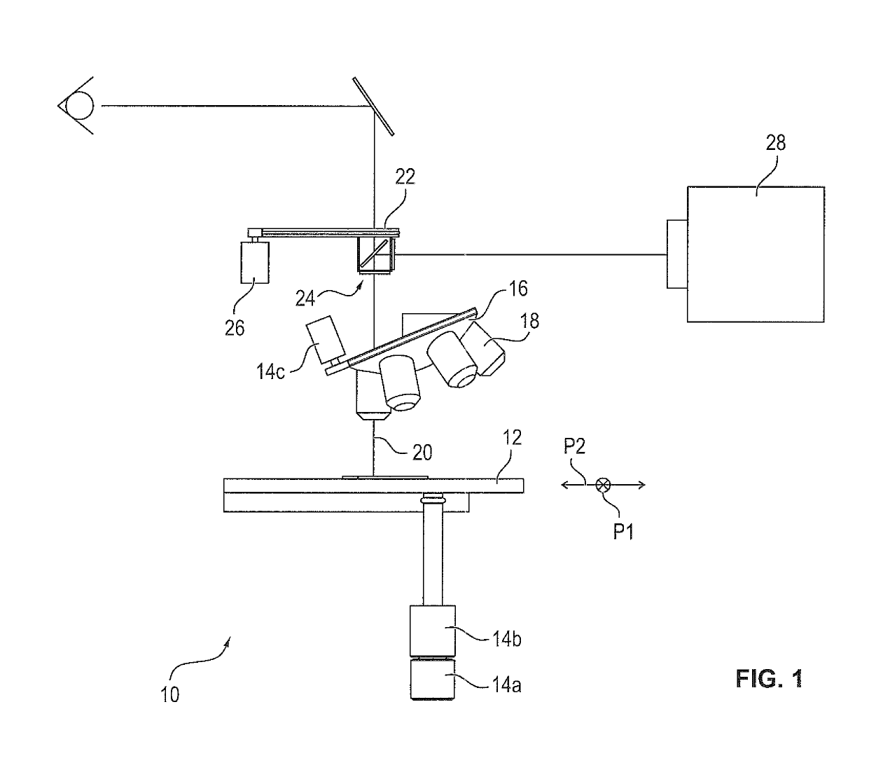

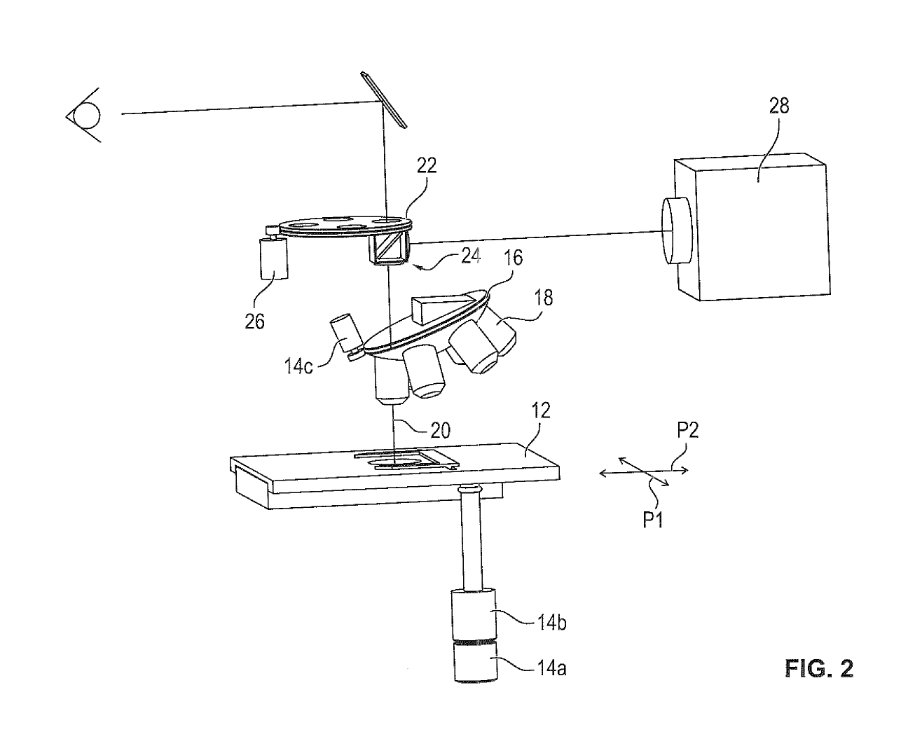

FIG. 1 is a highly simplified schematic depiction of an upright microscope 10. FIG. 2 is a perspective schematic depiction of microscope 10 according to FIG. 1. Only the relevant functional parts of microscope 10 are respectively shown.

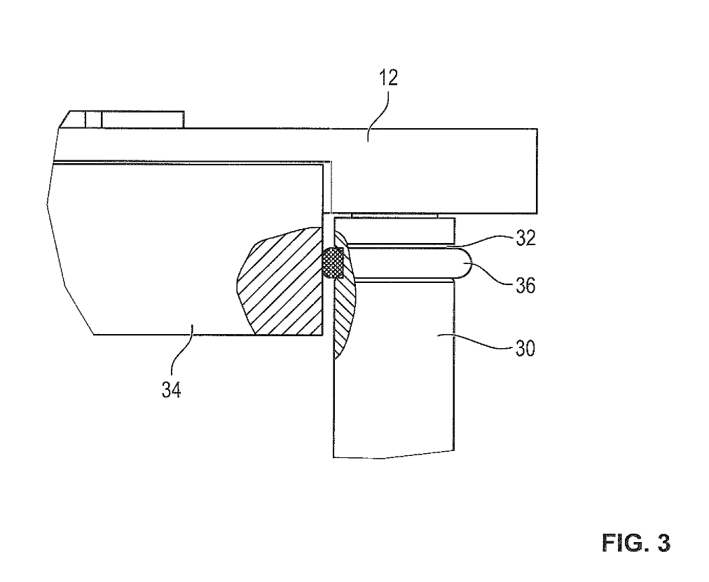

Microscope 10 comprises a specimen stage 12 on which the specimens to be microscopically examined are mounted. Specimen stage 12 is movable in an X direction, indicated by double arrow P1, with the aid of a drive unit 14. Embodied for this purpose between drive unit 14 and specimen stage 12 is a frictionally engaging connection that will be described later in further detail in conjunction with FIG. 3.

Microscope 10 furthermore comprises an objective turret 16 that comprises a plurality of objectives, one of which is labeled by way of example with the reference character 18. A different objective 18 is pivoted into beam path 20 of microscope 10 depending on the rotational position of objective turret 16.

Microscope 10 furthermore has a rotary disk 22 on which fluorescence cubes and/or other optical objects can be fastened. In the example shown in FIGS. 1 and 2, only one fluorescence cube 24 is received in rotary disk 22.

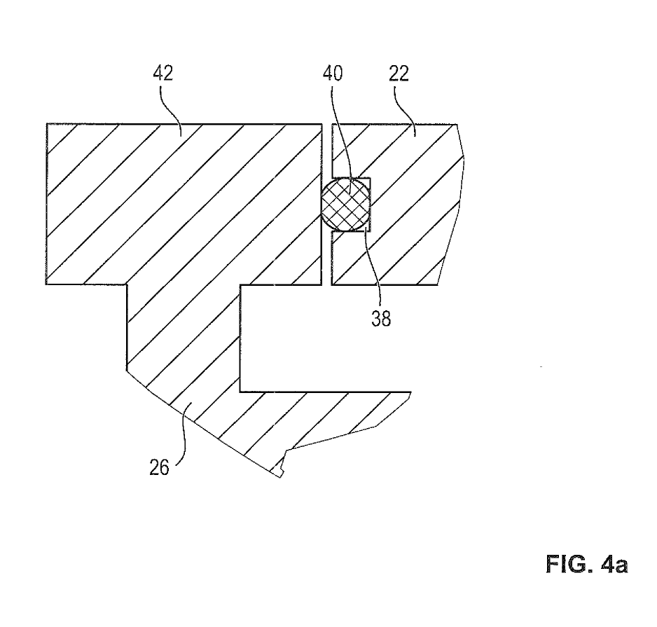

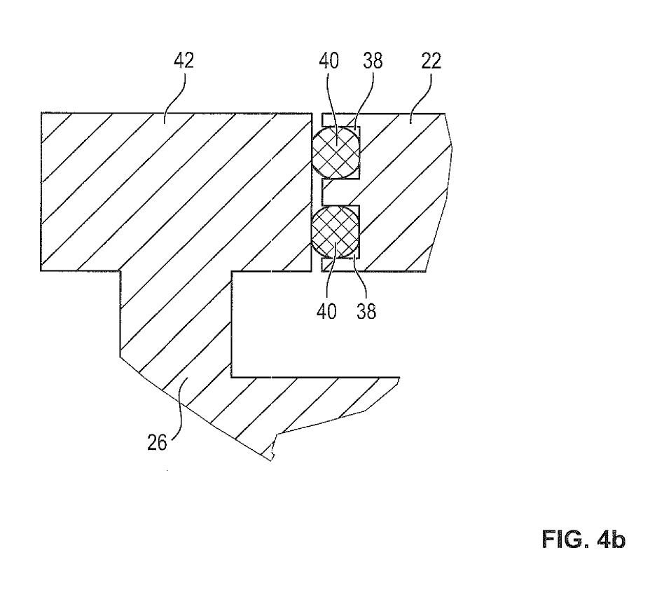

Rotary disk 22 is rotatable via a drive unit 26; here as well, the coupling between rotary disk 22 and drive unit 26 is embodied in frictionally engaging fashion, as will be described further in conjunction with FIG. 4.

Microscope 10 furthermore has an illumination unit 28 for illuminating the specimen to be microscopically examined.

FIG. 3 is a partly sectioned depiction of specimen stage 12 and of drive unit 14. Drive unit 14 comprises a first coupling element 30 that is coupled to a second coupling element 34 of specimen stage 12. First coupling element 30 is embodied in particular in the form of a shaft rotatable via drive unit 14, and second coupling element 34 is embodied in particular as a rod.

First coupling element 30 comprises a circumferential groove 32 in which an elastic element 36 in the form of an elastic ring is received. The spacing between first coupling element 30 and second coupling element 34 is selected to be such that elastic element 36 becomes elastically deformed and is thus preloaded between the two coupling elements 30 and 34. Upon rotation of first coupling element 30, a corresponding force is transferred to second coupling element 34 by way of the friction existing between elastic element 36 and second coupling element 34, so that the latter is moved in the desired direction.

A frictionally engaging force transfer between drive unit 14 and specimen stage 12 is thereby achieved in simple fashion.

FIG. 4a is a sectioned depiction of a portion of rotary disk 22 and of drive unit 26. Rotary disk 22 comprises a circumferential groove 38 in which an elastic element 40, likewise embodied as a ring, is arranged. The spacing between rotary disk 22 and drive unit 26 is once again selected in such a way that elastic element 40 becomes elastically deformed and is thus preloaded. A frictionally engaging force transfer between drive unit 26 and rotary disk 22 is thereby once again achieved in particularly simple fashion. Upon rotation of wheel 42 of drive unit 26, a force is transferred from drive unit 26 to rotary disk 22 by way of the frictional force existing between wheel 42 and elastic element 40, so that rotary disk 22 is rotated in the desired direction.

Both elastic element 36 and elastic element 40 are produced in particular from EPDM, which has the advantage on the one hand that a high coefficient of friction exists and thus a large frictional force is transferred, and on the other hand that the elastic element is subject to very little or no aging.

FIG. 4b is a sectioned depiction of a portion of rotary disk 22 and of drive unit 26 in accordance with an alternative embodiment. In this embodiment, two elastic elements 40 are arranged between rotary disk 22 and drive unit 26.

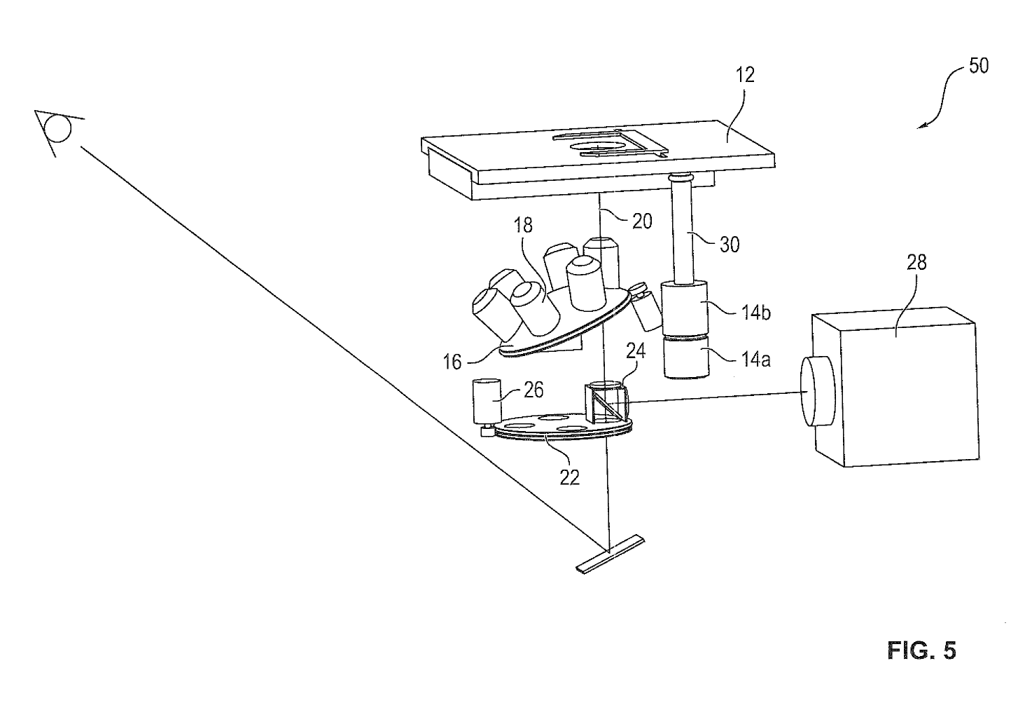

FIG. 5 is a schematic and likewise highly simplified depiction of an inverted microscope 50. Elements having the same construction or the same function have the same reference characters.

In this inverted microscope, objective turret 16 is arranged below specimen stage 12, so that the object that is to be microscopically examined and is arranged on specimen stage 12 can be viewed from below.

With this inverted microscope 50 as well, the coupling between drive unit 14 and specimen stage 12, and the coupling between rotary disk 22 and drive unit 26, are embodied as a frictionally engaging connection and, in particular, are embodied analogously to the exemplifying embodiment of FIGS. 3 and 4.

In an alternative embodiment of the invention a further drive unit can also be provided, by way of which specimen stage 12 can be moved in a Y direction arranged orthogonally to the X direction. The connection between this further drive unit and specimen stage 12 is, in particular, also embodied in frictionally engaging fashion.

In a further alternative embodiment, a further drive unit by way of which the objective turret can be rotated can also be additionally or alternatively provided. The connection between the objective turret and this further drive unit is, in particular, also embodied as a frictionally engaging connection.

Further drive units for moving further movable elements within the microscope, which units in particular can likewise be coupled to the respective element via a frictionally engaging connection, can furthermore also be provided.

The use of frictionally engaging connections has the advantage, as compared with positively engaging connections such as gears, toothed racks, spindles, or toothed belts, that manufacturing costs are substantially lower, since positively engaging connections of this kind must be manufactured and assembled with high precision for smooth operation of the corresponding movable elements. With the frictionally engaging connections, tolerances are automatically compensated for by the elasticity of elastic elements 36, 40, so that very smooth and precise operation is achieved even with larger tolerances.

With conventional positively engaging drives a reversing backlash furthermore exists, resulting in a hysteresis upon reversal of the rotation direction or motion direction. Transfer via a frictionally engaging connection has the advantage that it is hysteresis-free, so that operating convenience is considerably enhanced.

The frictionally engaging connections are furthermore substantially quieter as compared with positively engaging connections. The positively engaging connections moreover require regular maintenance, in particular because the components used therein must be regularly lubricated. This is not the case with the frictionally engaging connections via elastic elements 36, 40, thus reducing maintenance outlay.

### PARTS LIST

10, 50 Microscope
12 Specimen stage
14a, b, c Drive units
16 Objective turret
18 Objective
20 Beam path
22 Rotary disk
24 Fluorescence cube
26 Drive unit
28 Illumination unit
30 Coupling element
32 Groove
34 Coupling element
36 Elastic element
38 Groove
40 Elastic element
42 Wheel
P1, P2 Direction

What is claimed is:

1. A microscope (10) comprising:
a specimen stage (12) movable in an X direction (P1) and/or a Y direction (P2),
an objective turret (16), and
a first drive unit (14a) with which the specimen stage (12) is movable in the X direction (P1), a second drive unit (14b) with which the specimen stage (12) is movable in the Y direction (P2), and/or a third drive unit (14c) with which the objective turret (16) is rotatable,
wherein a respective frictional connection for transferring a torque and/or a force is embodied between the first drive unit (14a) and the specimen stage (12), between the second drive unit (14b) and the specimen stage (12), and/or between the third drive unit (14c) and the objective turret (16).

2. The microscope (10, 50) according to claim 1, wherein the torque transfer and/or force transfer occurs exclusively by way of the friction existing between the respective drive unit (14a, 14b, 14c) and the specimen stage (12) or objective turret (16).

3. The microscope (10, 50) according to claim 1, wherein the frictional connection between the respective drive unit (14a, 14b, 14c) and the specimen stage (12) or objective turret (16) is non-toothed.

4. The microscope (10, 50) according to claim 1, wherein a flexible frictional drive is embodied respectively between the first drive unit (14a) and the specimen stage (12), between the second drive unit (14b) and the specimen stage (12), and/or between the third drive unit (14c) and the objective turret (16).

5. The microscope (10, 50) according to claim 1, wherein the first, the second, and/or the third drive unit (14a, 14b, 14c) respectively comprises a first coupling element (30); the specimen stage (12) and/or the objective turret (16) respectively comprises a second coupling element (34); and the first and second coupling elements (30, 34) are coupled in frictionally engaging fashion to one another.

6. The microscope (10, 50) according to claim 5, wherein at least one elastic element (36) is arranged nonpositively between the first and second coupling elements (30, 34) and is thereby preloaded.

7. The microscope (10, 50) according to claim 6, wherein the at least one elastic element (36) is made of rubber.

8. The microscope (10, 50) according to claim 6, wherein the at least one elastic element (36) is made of ethylene propylene diene rubber (EPDM).

9. The microscope (10, 50) according to claim 6, wherein the elastic element (36) is fastened in nonrotating and stationary fashion on the first and/or the second coupling element (30, 34).

10. The microscope (10, 50) according to claim 9, wherein the coupling element (30, 34) on which the elastic element (36) is fastened comprises a groove (32) in which the elastic element (36) is at least partly arranged.

11. The microscope (10, 50) according to claim 5, wherein at least two elastic elements (36) are arranged nonpositively between the two coupling elements (30, 34) and are thereby preloaded.

12. The microscope (10, 50) according to claim 11, wherein the at least two elastic elements (36) are arranged with a mutual offset so that the at least two elastic elements (36) do not contact one another.

13. The microscope (10, 50) according to claim 5, wherein the first coupling element (30) is embodied as a wheel or shaft.

14. The microscope (10, 50) according to claim 13, wherein an elastic element (36) is arranged nonpositively between the first and second coupling elements (30, 34) and is thereby preloaded, wherein the elastic element (36) extends around the entire circumference of the first coupling element (30).

15. The microscope (10, 50) according to claim 5, wherein the second coupling element (34) is embodied as a wheel or rod.

16. The microscope (10, 50) according to claim 5, wherein the first, the second, and/or the third drive unit (14a, 14b, 14c) respectively comprises an electric motor having a drive shaft, wherein the first coupling element (30) is mounted on the drive shaft or the drive shaft is the first coupling element.

17. The microscope (10, 50) according to claim 1, further comprising:
a rotary disk (22) in which are arranged fluorescence cubes (24) and/or other optical elements that are selectably introducible into a beam path of the microscope;
a fourth drive unit (26) by way of which the rotary disk (22) is rotatable; and
a frictional connection between the fourth drive unit (26) and the rotary disk (22) for transferring from the fourth drive unit (26) to the rotary disk (22) a torque and/or a force for rotating the rotary disk (22).
